(19) United States
(12) Patent Application Publication
(10) Pub. No.: US 2025/0037902 A1
(43) Pub. Date: Jan. 30, 2025

(54) AUXILIARY WIRE, FLAT CABLE AND ROUND CABLE

(71) Applicant: Shanghai Lanhao Electric Co., Ltd., Shanghai (CN)

(72) Inventors: Zhangxing QIAN, Shanghai (CN); Bingbing WANG, Shanghai (CN); Jingjing DING, Shanghai (CN); Chaoyong LIN, Shanghai (CN); Chunyan LIU, Shanghai (CN)

(21) Appl. No.: 18/490,600

(22) Filed: Oct. 19, 2023

(30) Foreign Application Priority Data
Jul. 26, 2023 (CN) 2023109216458

(51) Int. Cl. H01B 7/18; H01B 5/10; H01B 7/08; H01B 7/22; H01B 11/22

(52) U.S. Cl. CPC H01B 7/1855; H01B 5/108; H01B 7/0823; H01B 7/226; H01B 11/22

(57) ABSTRACT

An auxiliary wire, a flat cable and a round cable are provided. Each of the flat cable and the round cable is provided with the auxiliary wire with the loose jacket protective layer.

### CROSS-REFERENCE TO RELATED APPLICATION

This patent application claims the benefit and priority of Chinese Patent Application No. 2023109216458 filed with the China National Intellectual Property Administration on Jul. 26, 2021, the disclosure of which is incorporated by reference herein in its entirety as part of the present application.

### TECHNICAL FIELD

The present disclosure relates to the technical field of cables, in particular to an auxiliary wire including a loose jacket protective structure, a flat cable and a round cable.

### BACKGROUND

The electric shovel tail wires and electric drill tail wires in open-pit coal mines, or cables of coal miners in underground coal mines, or reel cables and towing cables used in port machinery and other equipment are not fixed in laying and using process, but the cables need to move. In the process of movement of the cables, the cables are repeatedly subjected to tensile force, torsion, bending, lateral pressure or external force impact. These factors cause the auxiliary wire such as a control wire, a communication wire and an optical fiber in the cable to be easily broken or damaged, so that the whole cable is out of action and scrapped. The reason that the auxiliary wire such as a control wire, a communication wire and an optical fiber is easy to be damaged is that the auxiliary wires are often very thin compared with power wires in the cables. For example, the cross-sectional area of the power wire is 185 mm², but the cross-sectional area of the control wire is only 4 mm². The cross-sectional area of the communication wire may be only 0.5 mm², and the diameter of the optical fiber is naturally smaller. So the tensile capacity of these auxiliary wires is poor. If there are no special protective measures, these auxiliary wires are often damaged quickly in the using process of the cable, so that the service life of the cable is seriously influenced.

### SUMMARY

The purpose of the present disclosure is to provide an auxiliary wire including a loose jacket protective layer, a flat cable and a round cable. The loose jacket protective layer can effectively protect the auxiliary wire such as a control wire, a communication wire and an optical fiber and prolong the service life of the auxiliary wire, so that the problem that an existing auxiliary wire is often damaged quickly to seriously affect the service life of the cable is solved.

In order to achieve the purpose, the present disclosure provides the following scheme.

The present disclosure provides an auxiliary wire, including:
an auxiliary wire core, including one wire core or being formed by twisting a plurality of wire cores;
a loose jacket protective layer, where the loose jacket protective layer sleeves outside of the auxiliary wire core and is able to slide along a length direction of the auxiliary wire core relative to the auxiliary wire core; the loose jacket protective layer is formed by tube extrusion of polymer materials or by winding a steel wire around the auxiliary wire core.

Optionally, the auxiliary wire further includes an outer protective layer of polymer material, where the outer protective layer of polymer material sleeves outside of the loose jacket protective layer.

Optionally, the auxiliary wire further includes a shielding layer sleeving an outer layer of the loose jacket protective layer.

Optionally, the auxiliary wire is a control wire, a communication wire or an optical fiber.

Optionally, when the auxiliary wire is a control wire or a communication wire, any wire core includes a wire core conductor and a wire core insulating layer sleeving the outside of the wire core conductor. When the auxiliary wire is an optical fiber, any wire core includes an optical fiber core and an optical fiber sleeve sleeving the outside of the optical fiber core.

The present disclosure further provides a flat cable, which includes a flat cable sheath, a power wire core and the auxiliary wire described above, where the power wire core and the auxiliary wire are both arranged in the flat cable sheath, and the power wire core and the auxiliary wire are arranged in parallel along a width direction of the flat cable sheath.

Optionally, three power wire cores, including a first power wire core, a second power wire core and a third power wire core, are provided; the first power wire core, the second power wire core and the third power wire core are arranged at equal intervals along the width direction of the flat cable sheath, and one auxiliary wire is arranged between the first power wire core and the second power wire core and another auxiliary wire is arranged between the second power wire core and the third power wire core; where the auxiliary wire between the first power wire core and the second power wire core is a control wire, and the control wire is externally tangential with the first power wire core and arranged at an interval with the second power wire core; and the auxiliary wire located between the second power wire core and the third power wire core is an optical fiber, and the optical fiber is externally tangential with the third power wire core and arranged at an interval with the second power wire core.

Optionally, the profile of the cross section of the flat cable sheath is a rectangular profile.

Optionally, the power wire core includes a power wire conductor, a power wire insulating layer and a metal shielding layer which are sequentially arranged from the inside to the outside.

The present disclosure further provides a round cable. The round cable includes a cable core and a round cable sheath covered outside of the cable core, where the cable core includes the auxiliary wire described above.

Optionally, the cable core is formed by twisting power wire cores, a ground wire core, a grounding detection wire core and the auxiliary wire described above, where the power wire cores include three power wire cores, the three power wire cores are mutually twisted tangentially in pair, the ground wire core, the grounding detection wire core and the auxiliary wire respectively include one ground wire core, one grounding detection wire core and one auxiliary wire, and the ground wire core, the grounding detection wire core and the auxiliary wire are respectively tangentially placed in gaps between every two adjacent power wire cores; and the auxiliary wire is a communication wire.

Optionally, the cable core is formed by twisting power wire cores, a ground wire core and the auxiliary wire described above, where the power wire cores include three power wire cores, the ground wire core and the auxiliary wire respectively include one ground wire core and one auxiliary wire, the auxiliary wire is a control wire or a communication wire, the auxiliary wire and the three power wire cores are mutually twisted tangentially in pair, and the ground wire core is located at a center position of the auxiliary wire and the three power wire cores.

Optionally, the round cable sheath is of single-layer sheath structure or a multi-layer sheath structure.

Optionally, the multi-layer sheath structure is of a double-layer structure, and includes an inner sheath layer and an outer sheath layer sleeving the outside of the inner sheath layer. A reinforcing layer is arranged between the inner sheath layer and the outer sheath layer.

Compared with the prior art, some embodiments have the following technical effects.

According to the auxiliary wire provided by some embodiments, by sleeving a loose jacket protective layer outside an auxiliary wire core, the purpose of protecting the auxiliary wire is achieved, and the durable time of the auxiliary wire is greatly prolonged, so that the service life of the cable is greatly prolonged, and the economic benefits of users are improved. At the same time, because the service life of the cable is prolonged, the production capacity of the cable can be reduced, and the consumption of electrolytic copper and polymer materials is reduced. Copper is smelted by electrolysis that consumes a lot of electric energy, and polymer materials basically come from non-renewable fossil energy sources such as petroleum, coal and natural gas. Therefore, by prolonging the service life of the cable, intuitive economic benefits can be brought to users, energy conservation and environmental protection are facilitated, and thus contributions are made to low-carbon and green economy.

In the flat cable and the round cable provided by the present disclosure, are each provided with the auxiliary wire with the loose jacket protective layer, so that the service life of the cable is greatly prolonged, and then the economic benefits of users are improved.

### BRIEF DESCRIPTION OF THE DRAWINGS

To more clearly illustrate the present embodiment of the present disclosure or the technical scheme in the prior art, the following briefly introduces the drawings to be used in the present embodiment. Apparently, the drawings in the following description show merely some embodiments of the present disclosure, and those skilled in the art may still derive other drawings from these drawings without creative efforts.

FIG. 1 is an external structural schematic diagram of an auxiliary wire disclosed in the first embodiment of the present disclosure.

FIG. 2 is an external structural schematic diagram of another auxiliary wire disclosed in the first embodiment of the present disclosure.

FIG. 3 is a cross-section structural schematic diagram of an auxiliary wire disclosed in the first embodiment of the present disclosure.

FIG. 4 is a cross-section structural schematic diagram of a flat cable disclosed in the second embodiment of the present disclosure.

FIG. 5 is a cross-section structural schematic diagram of a round cable disclosed in the third embodiment of the present disclosure.

FIG. 6 is a cross-section structural schematic diagram of a round cable disclosed in the fourth embodiment of the present disclosure.

FIG. 7 is a cross-section structural schematic diagram of a round cable disclosed in the fifth embodiment of the present disclosure.

FIG. 8 is a cross-section structural schematic diagram of a round cable disclosed in the sixth embodiment of the present disclosure.

FIG. 9 is a cross-section structural schematic diagram of a round cable disclosed in the seventh embodiment of the present disclosure.

### REFERENCE SIGNS IN THE ATTACHED FIGURES

100 flat cable; 200 round cable;
1 auxiliary wire; 11 auxiliary wire core; 111 wire core conductor; 112 wire core insulating layer; 12 loose jacket protective layer; 13 outer protective layer of polymer material; 14 shielding layer; 15 optical fiber sleeve;
2 flat cable sheath;
3 power wire core; 31 power wire conductor; 32 power wire insulating layer; 33 metal shielding layer; 34 power wire conductor shielding layer; 35 insulating semi-conducting shielding layer;
4 round cable sheath;
5 ground wire core;
6 grounding detection wire core; 61 grounding detection wire conductor; and 62 grounding detection wire insulating layer.

### DETAILED DESCRIPTION OF THE EMBODIMENTS

The following clearly and completely describes the technical scheme in the embodiments of the present disclosure with reference to the embodiments of the present disclosure. Apparently, the described embodiments are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

One of the purposes of the present disclosure is to provide an auxiliary wire including a loose jacket protective layer. The loose jacket protective layer can effectively protect the auxiliary wire such as a control wire, a communication wire and an optical fiber and prolong the service life of the auxiliary wire, so that the problem that an existing auxiliary wire is often damaged quickly to seriously affect the service life of the cable is solved.

Another purpose of the present disclosure is to further provide a flat cable with the auxiliary wire.

Then, a further purpose of the present disclosure is to further provide a round cable with the auxiliary wire.

To make the above-mentioned purposes, features and advantages of the present disclosure apparent and understandable, the present disclosure is further described in detail below with reference to the drawings and specific embodiments.

### The First Embodiment

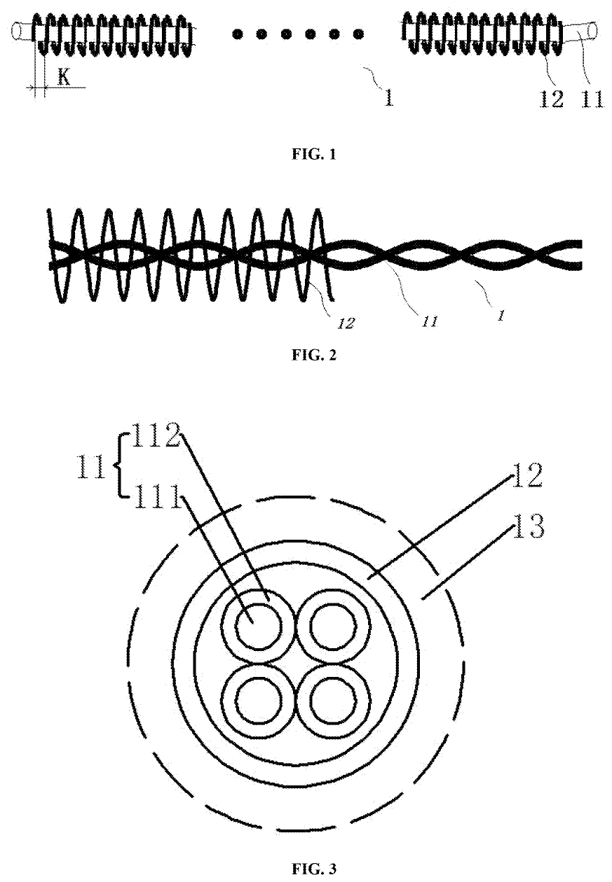

As shown in FIG. 1 to FIG. 3, the embodiment provides an auxiliary wire 1. The auxiliary wire 1 includes an auxiliary wire core 11 and a loose jacket protective layer 12. The auxiliary wire core 11 includes one wire core or is formed by twisting multiple wire cores. As shown in FIG. 1, the auxiliary wire core 11 includes one wire core. As shown in FIG. 2, the auxiliary wire core 11 is formed by twisting two wire cores. When the auxiliary wire core 11 includes three or more than three wire cores, the wire cores are generally tangentially twisted. The composition form and the twisting mode of the auxiliary wire core 11 are related to the prior art and are not described here. The loose jacket protective layer 12 sleeves the outside of the auxiliary wire core 11, and the inner diameter of the loose jacket protective layer 12 is slightly larger than the maximum outer diameter of the auxiliary wire core 11, so that a space for relative movement of the auxiliary wire core 11 relative to the loose jacket protective layer 12 is ensured. That is, the auxiliary wire core 11 can freely slide along the length direction of the auxiliary wire core 11 relative to the loose jacket protective layer 12 in normal using conditions. The loose jacket protective layer 12 can be formed by tube extrusion of polymer materials with a certain hardness or formed by winding a steel wire around the auxiliary wire core 11. When the loose jacket protective layer 12 is made of the steel wire, a round steel wire, a flat steel wire or other special-shaped steel wires can be used, and a gap K needs to be formed between two adjacent circles wound by the steel wire, and the size of the gap K should meet the requirements of the bending radius of the auxiliary wire or cable. The loose jacket protective layer 12 formed by tube extrusion of the polymer materials is in the shape of a tube without considering the above gap K. The polymer materials may be thermoplastic materials or cross-linked elastomer materials. In the bending process of the loose jacket protective layer 12 made of the polymer materials, even if friction occurs between an inner wall of the loose jacket protective layer 12 and the inner auxiliary wire core 11, the core wire cannot be damaged.

In the scheme, the auxiliary wire core 11 of the auxiliary wire is arranged in a special loose jacket protective layer 12 to play a role in protecting a thinner auxiliary wire core in the cable, so that the thinner wire core in the cable is higher in durability in the mobile application of cables and is beneficial to long-term use without easy damage, so that the service life of the wire core is prolonged, the service life of the cable is also prolonged, and the economic benefits are improved. The thinner core of the cable is the auxiliary wire core 11, and specifically can be a control wire, a communication wire, a single wire core or a multi-core combined wire core. The thinner wire core is characterized in that the cross-sectional area of the wire core is generally less than 10 mm² or the wire core is an optical fiber unit. “Mobile application of cables” means that cables are constantly moving or traveling in use, instead of being fixedly laid. For example, the cable may be a coal cutter cable, an open-pit shovel tail cable and other cables. Some cables, such as reel cables on port machinery equipment, need to be wound in reels and continuously taken in and out. Some cables, such as towing cables, need to be erected in towing racks and move with cable hooks.

In the embodiment, the auxiliary wire further includes an outer protective layer 13 of polymer material sleeving the outside of the loose jacket protective layer 12. The outer protective layer 13 may be of a single-layer structure or a double-layer structure, the material of the outer protective layer 13 may be rubber (such as ethylene propylene rubber, chloroprene rubber or chlorinated polyethylene rubber), an elastomer, and other suitable polymer materials, and the colors thereof may be black, full colors, translucent colors, and transparent colors. Generally, the outer protective layer 13 may or may not be provided according to the design requirements.

In the embodiment, the auxiliary wire further includes a shielding layer 14 sleeving the outermost layer of the loose jacket protective layer 12. In the scheme, when the outer protective layer 13 does not sleeve the outside of the loose jacket protective layer 12, the outermost layer of the loose jacket protective layer 12 is an outer layer of the loose jacket protective layer 12, and the shielding layer 14 directly sleeves the outside of the loose jacket protective layer 12. When the outer protective layer 13 sleeves the outside of the loose jacket protective layer 12, the outermost layer of the loose jacket protective layer 12 is the outer layer of the outer protective layer 13, and the shielding layer 14 sleeves the outside of the outer protective layer 13. The shielding layer 14 may or may not be provided according to actual requirements. When the shielding layer 14 is provided, the shielding layer 14 may be a metal wire braided shielding layer, a metal wire/fiber braided shielding layer, or a metal wire wound shielding layer. When the auxiliary wire 1 is applied to cable, the outermost layer is generally provided with a shielding layer 14.

In the embodiment, the auxiliary wire 1 specifically can be a control wire, a communication wire or an optical fiber. In general, when the auxiliary wire 1 is a control wire or a communication wire, any wire core includes a wire core conductor 111 and a wire core insulating layer 112 sleeving the outside of the wire core conductor 111. When the auxiliary wire 1 is an optical fiber, any wire core includes an optical fiber core and an optical fiber sleeve 15 sleeving the outside of the optical fiber core. When multiple optical fiber sleeves 15 are provided, the optical fiber sleeves 15 are twisted to form an auxiliary wire core 11. The wire core arrangement of the control wire, the communication wire and the optical fiber are all related to the prior art, and are not be described here.

The auxiliary wire 1 can be applied to existing cables. The cable core can only include the auxiliary wire 1, or besides auxiliary wire 1, a power wire core, a ground wire core and a grounding detection wire core are further arranged. Generally, it is necessary to select the composition and structure of cable core according to the cable installation and laying conditions. According to different application occasions and environments, the cable can be of a round structure, a flat structure or other special-shaped structures. In the round cable, the wire cores are twisted into a cable core. In the flat cable, the wire cores are arranged in parallel. No matter which kind of form, the outer side of the wire core is coated with an outer sheath of the cable.

It can be seen that in the scheme, the service life of an originally non-durable auxiliary wire is prolonged by providing a special protection structure, that is, the loose jacket protective layer 12, for the auxiliary wire. So that the service life of the cable is prolonged as a whole, direct economic benefits are brought to users, and real contributions are made to the green and low-carbon economy.

In practical application, preferably, the loose jacket protective layer 12 is formed by tube extrusion of polymer materials with a certain hardness. Compared with a steel wire winding process, the process of the tube extrusion of polymer materials is more mature, the production speed of the tube extrusion of polymer materials is higher, the weight of the loose jacket protective layer 12 is lighter, and the lightweight of cables is realized more easily.

### The Second Embodiment

The embodiment provides a flat cable 100. The flat cable 100 includes a flat cable sheath 2, a power wire core 3 and an auxiliary wire 1 disclosed in the first embodiment. The power wire core 3 and the auxiliary wire 1 are both embedded in the flat cable sheath 2, and the power wire core 3 and the auxiliary wire 1 are arranged in parallel along the width direction of the flat cable sheath 2. The flat cable sheath 2 is made of conventional cable sheath materials, and the cross section thereof is non-circular and flat. For example, the profile of the cross section of the flat cable sheath 2 is a rectangular profile or an elliptical profile. The flat structure of the flat cable 100 is beneficial to reduce the outer diameter of the cable. Compared with a common round cable, the bending radius of the flat cable can be reduced by ½, and the flat cable cannot be distorted during moving, so that the service life of the flat cable is prolonged.

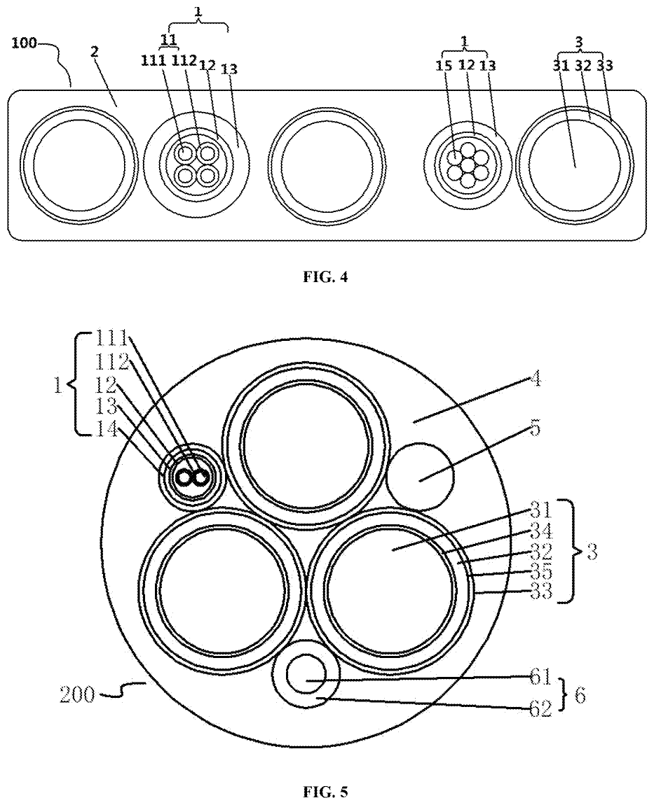

As shown in FIG. 4, the profile of the cross section of the flat cable sheath 2 is a rectangular profile. Three power wire cores 3, including a first power wire core, a second power wire core and a third power wire core, are arranged. The first power wire core, the second power wire core and the third power wire core are sequentially arranged at equal intervals along the width direction of the flat cable sheath 2 from left to right (the width direction is the length direction of the rectangular profile). One auxiliary wire is arranged between the first power wire core and the second power wire core and another auxiliary wire is arranged between the second power wire core and the third power wire core. The auxiliary wire 1 between the first power wire core and the second power wire core is a control wire, and the control wire is externally tangential with the first power wire core and arranged at an interval with the second power wire core. An interval between the control wire and the second power wire core is filled with materials of the flat cable sheath 2 to form sheath reinforcing ribs. The sheath reinforcing ribs are a part of an integral structure of the flat cable sheath 2. Correspondingly, the auxiliary wire 1 located between the second power wire core and the third power wire core is an optical fiber, the optical fiber is externally tangential with the third power wire core and arranged at an interval with the second power wire core. The interval between the optical fiber and the second power wire core is filled with materials of the flat cable sheath 2 to form sheath reinforcing ribs. The sheath reinforcing ribs are a part of the integral structure of the flat cable sheath 2.

In the embodiment, the power wire core 3 includes a power wire conductor 31, a power wire insulating layer 32 and a metal shielding layer 33 which are sequentially arranged from the inside to the outside. When the voltage level of the cable is less than 3 kV, the power wire core 3 can be of the above structure. When the voltage level of the cable exceeds 6 kV, a shielding layer needs to be added to the power wire core correspondingly. For example, a power wire conductor shielding layer 34 is additionally arranged between the power wire conductor 31 and the power wire insulating layer 32, and an insulating semi-conducting shielding layer 35 is additionally arranged between the power wire insulating layer 32 and the metal shielding layer 33. That is, the finally formed power wire core 3 sequentially includes a power wire conductor 31, a power wire conductor shielding layer 34, a power wire insulating layer 32, an insulating semi-conducting shielding layer 35 and a metal shielding layer 33 from the inside to the outside. The power wire core 3 is a conventional wire core in cables, and the specific structure and functional principle of the power wire core 3 are not described here.

In the embodiment, the flat cable sheath 2 is generally a single-layer sheath structure. The single-layer sheath structure may be made of rubber (such as chloroprene rubber or chlorinated polyethylene rubber), an elastomer, and other suitable polymer materials, and the colors thereof may be black, full colors, translucent colors, and transparent colors.

In the flat cable 100 of the scheme, the inner wire cores are arranged in parallel side by side, and the outer diameter of the cable is reduced, which is suitable for use occasions with narrow space. Compared with the round cable, the bending radius of the flat cable can be reduced by ½. At the same time, the flat cable cannot be distorted even in the moving process after being installed and laid, so that the problem that the wire core of the cable is broken due to the distortion of the cable is avoided, and the cable has a longer service life.

### The Three Embodiment

The embodiment provides a round cable 200. The round cable 200 includes a cable core and a round cable sheath 4 covered on the outside of the cable core. The cable core is formed by twisting power wire cores 3, a ground wire core 5, a grounding detection wire core 6 and the auxiliary wire 1 described above. Three power wire cores 3 are provided, and the three power wire cores 3 are twisted tangentially in pair. One ground wire core 5, one grounding detection wire core 6 and one auxiliary wire 1 are provided. The ground wire core 5, the grounding detection wire core 6 and the auxiliary wire 1 are respectively tangentially placed in gaps between every two adjacent power wire cores 3. The auxiliary wire 1 is a communication wire. The round cable 200 with a round cross section has better crosswind resistance performance.

In the embodiment, the power wire core 3 includes a power wire conductor 31, a power wire insulating layer 32 and a metal shielding layer 33 which are sequentially arranged from the inside to the outside. When the voltage level of the cable is less than 3 kV, the power wire core 3 can be of the above structure. When the voltage level of the cable exceeds 6 kV, a shielding layer needs to be added to the power wire core correspondingly. For example, a power wire conductor shielding layer 34 is additionally arranged between the power wire conductor 31 and the power wire insulating layer 32, and an insulating semi-conducting shielding layer 35 is additionally arranged between the power wire insulating layer 32 and the metal shielding layer 33. That is, the finally formed power wire core 3 sequentially includes a power wire conductor 31, a power wire conductor shielding layer 34, a power wire insulating layer 32, an insulating semi-conducting shielding layer 35 and a metal shielding layer 33 from the inside to the outside. The power wire core 3 is a conventional wire core in cables, and the specific structure and functional principle of the power wire core 3 are not described here.

In the embodiment, the conductor stranded lay ratio of the power wire core 3 is 2 to 30.

In the embodiment, the cable lay ratio of the cable core is 2 to 12.

In the embodiment, the ground wire core 5 is a bare ground wire conductor or a semi-conducting layer or an insulating layer outside the ground wire conductor.

In the embodiment, the grounding detection wire core 6 includes a grounding detection wire conductor 61 and a grounding detection wire insulating layer 62 covered on the outside of the grounding detection wire conductor 61.

In the embodiment, the flat cable sheath 4 can be of a double-layer sheath structure or a single-layer sheath structure. The single-layer sheath structure can be made of rubber (such as neoprene rubber and chlorinated polyethylene rubber), an elastomer and other suitable polymer materials, and the colors thereof can be black, full colors, translucent color and transparent color. When the round cable sheath 4 is of a double-layer sheath structure, the round cable sheath 4 includes an inner sheath layer and an outer sheath layer sleeving the outside of the inner sheath layer, both the inner sheath layer and the outer sheath layer can be made of rubber, an elastomer and other suitable polymer materials, and the colors thereof can be black, full colors, translucent color and transparent color. A reinforcing layer can further be arranged between the inner sheath layer and the outer sheath layer, and the reinforcing layer can specifically be a fiber braided reinforcing layer or a metal wire wound reinforcing layer. The sheath layer is generally arranged according to the design requirements, and may or may not be arranged.

Compared with the flat cable structure, the round cable 200 provided by the technical scheme has better crosswind resistance performance and smaller wind receiving area, and is suitable for use in ports, mines and other occasions. Compared with a conventional cable, the round cable 200 in the technical scheme is additionally provided with a ground wire and a grounding detection wire core. Compared with a metal braided ground wire, the independent ground wire has longer service life and better grounding safety performance. Meanwhile, the added grounding detection wire core can detect the loop safety of the ground wire core in real time, so that the safety performance of the cable is greatly improved.

In actual operation, either the ground wire core 5 or the grounding detection wire core 6 is arranged in the round cable 200 according to actual requirements, or neither the ground wire core 5 nor the grounding detection wire core 6 is arranged. If one or both of the ground wire core 5 and the grounding detection wire core 6 is or are omitted, the positions thereof may be vacant or replaced with an auxiliary wire 1, an optical fiber unit, a lamp strip or other functional units.

### The Fourth Embodiment

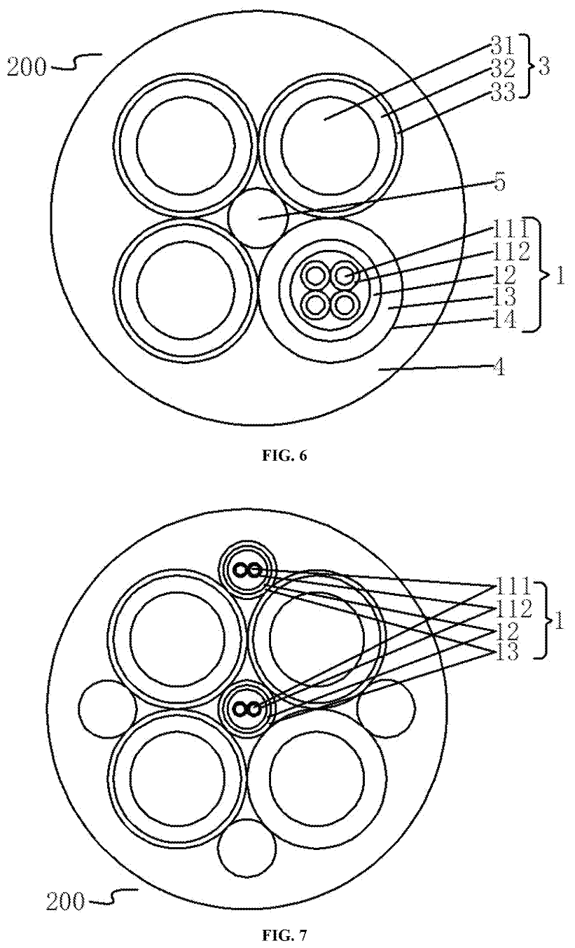

The embodiment provides a round cable 200. The round cable 200 includes a cable core and a round cable sheath 4 covered on the outside of the cable core. The cable core is formed by twisting power wire cores 3, a ground wire core 5 and the auxiliary wire 1 described above, where three power wire cores 3 are provided, one ground wire core 5 and one auxiliary wire 1 are provided, the auxiliary wire 1 is a control wire or a communication wire, the auxiliary wire 1 and the three power wire cores 3 are tangentially twisted in pair, and the ground wire core 5 is located at the center of the auxiliary wire 1 and the three power wire cores 3. As a preferred scheme, as shown in FIG. 6, the auxiliary wire 1 and the three power wire cores 3 are the same in outer diameters, the ground wire core 5 is located at the center of the auxiliary wire 1 and the three power wire cores 3, and the auxiliary wire 1 and the three power wire cores 3 are each externally tangential with the ground wire core 5. In the cable core, the connecting lines passing through the centers of the three power wire cores 3 and the center of the auxiliary wire 1 form a square. The stranded lay ratio of the cable core is 9.

In the embodiment, the power wire core 3 includes a power wire conductor 31, a power wire insulating layer 32 and a metal shielding layer 33 which are sequentially arranged from the inside to the outside. When the voltage level of the cable is less than 3 kV, the power wire core 3 can be of the above structure. When the voltage level of the cable exceeds 6 kV, a shielding layer needs to be added to the power wire core correspondingly. For example, a power wire conductor shielding layer 34 is additionally arranged between the power wire conductor 31 and the power wire insulating layer 32, and an insulating semi-conducting shielding layer 35 is additionally arranged between the power wire insulating layer 32 and the metal shielding layer 33 That is, the finally formed power wire core 3 sequentially includes a power wire conductor 31, a power wire conductor shielding layer 34, a power wire insulating layer 32, an insulating semi-conducting shielding layer 35 and a metal shielding layer 33 from the inside to the outside. The power wire core 3 is a conventional wire core in cables, and the specific structure and functional principle of the power wire core 3 are not described here.

In the embodiment, the stranded lay ratio of the power wire core 3 is 2 to 30.

In the embodiment, the ground wire core 5 is a bare ground wire conductor or a semi-conducting layer or an insulating layer outside the ground wire conductor.

In the embodiment, the flat cable sheath 4 can be of a double-layer sheath structure or a single-layer sheath structure. The single-layer sheath structure can be made of rubber (such as neoprene rubber and chlorinated polyethylene rubber), an elastomer and other suitable polymer materials, and the colors thereof can be black, full colors, translucent color and transparent color. When the round cable sheath 4 is of a double-layer sheath structure, the round cable sheath 4 includes an inner sheath layer and an outer sheath layer sleeving the outside of the inner sheath layer. Both the inner sheath layer and the outer sheath layer can be made of rubber, an elastomer and other suitable polymer materials, and the colors thereof can be black, full colors, translucent color and transparent color. A reinforcing layer can further be arranged between the inner sheath layer and the outer sheath layer, and the reinforcing layer can specifically be a fiber braided reinforcing layer or a metal wire wound reinforcing layer. The sheath layer is generally arranged according to the design requirements, and may or may not be arranged.

Compared with the flat cable structure, the round cable 200 provided by the technical scheme has better crosswind resistance performance and smaller wind receiving area, and is suitable for use in ports, mines and other occasions. Compared with a conventional cable, the round cable 200 in the technical scheme is additionally provided with a ground wire. Compared with a metal braided ground wire, the independent ground wire has longer service life and better grounding safety performance, and the safety performance of the cable is greatly improved.

### The Fifth Embodiment

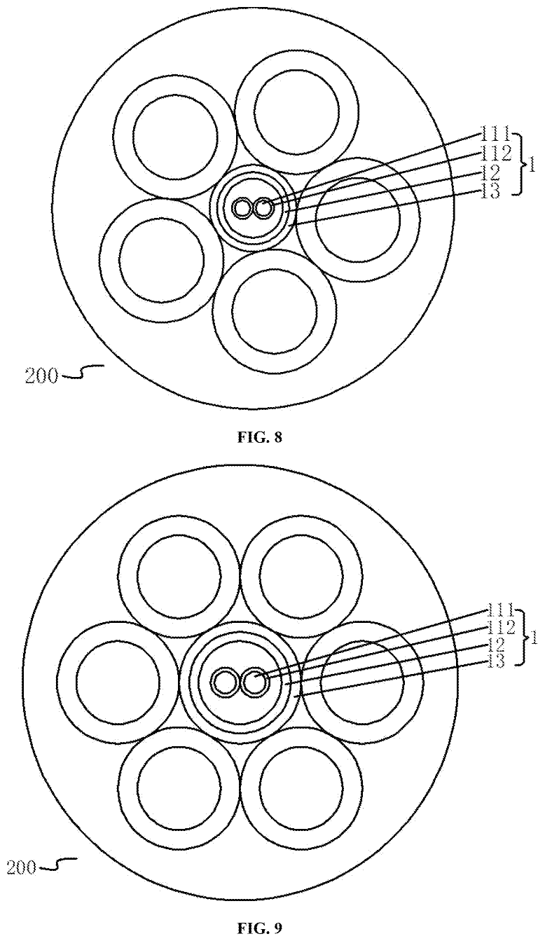

The embodiment provides a round cable 200. The round cable 200 includes a cable core and a round cable sheath 4 covered on the outside of the cable core. The cable core includes the auxiliary wire 1 described above and multiple other wire cores. Power wires or other functional units can be arranged in the cable core according to requirements, and the auxiliary wire 1 can be arranged at any position in the cable core regardless of how many power wires or other functional units there are in the cable. As shown in FIG. 7, the cable core includes two auxiliary wires 1, and the two auxiliary wires 1 are respectively located at the center of the cable core and an edge gap position of the power wire cores around the wire cores.

In the embodiment, the flat cable sheath 4 can be of a double-layer sheath structure or a single-layer sheath structure. The single-layer sheath structure can be made of rubber (such as neoprene rubber and chlorinated polyethylene rubber), an elastomer and other suitable polymer materials, and the colors thereof can be black, full colors, translucent color and transparent color. When the round cable sheath 4 is of a double-layer sheath structure, the round cable sheath 4 includes an inner sheath layer and an outer sheath layer sleeving the outside of the inner sheath layer. Both the inner sheath layer and the outer sheath layer can be made of rubber, an elastomer and other suitable polymer materials, and the colors thereof can be black, full colors, translucent color and transparent color. A reinforcing layer can further be arranged between the inner sheath layer and the outer sheath layer, and the reinforcing layer can specifically be a fiber braided reinforcing layer or a metal wire wound reinforcing layer. The sheath layer is generally arranged according to the design requirements, and may or may not be arranged.

The round cable provided by the technical scheme is provided with the auxiliary wire 1 including the loose jacket protective layer 1, so that the service life of the cable is greatly prolonged, and then the economic benefits of users improved.

### The Sixth Embodiment

The embodiment provides a round cable 200. As shown in FIG. 8, the difference of the sixth embodiment from the fifth embodiment only lies in that the cable core includes one auxiliary wire 1, and the auxiliary wire 1 is located at the center of the cable core. Five of the power wire cores and ground wire cores are arranged around the periphery of the auxiliary wire 1 and tangential with the auxiliary wire 1 in pair.

In the embodiment, the flat cable sheath 4 outside the cable core can be of a double-layer sheath structure or a single-layer sheath structure. The single-layer sheath structure can be made of rubber (such as neoprene rubber and chlorinated polyethylene rubber), an elastomer and other suitable polymer materials, and the colors thereof can be black, full colors, translucent color and transparent color. When the round cable sheath 4 is of a double-layer sheath structure, the round cable sheath 4 includes an inner sheath layer and an outer sheath layer sleeving the outside of the inner sheath layer. Both the inner sheath layer and the outer sheath layer can be made of rubber, an elastomer and other suitable polymer materials, and the colors thereof can be black, full colors, translucent color and transparent color. A reinforcing layer can further be arranged between the inner sheath layer and the outer sheath layer, and the reinforcing layer can specifically be a fiber braided reinforcing layer or a metal wire wound reinforcing layer. The sheath layer is generally arranged according to the design requirements, and may or may not be arranged.

The round cable provided by the technical scheme is provided with the auxiliary wire 1 with the loose jacket protective layer, 1, so that the service life of the cable is greatly prolonged, and then the economic benefits of users improved.

### The Seventh Embodiment

The embodiment provides a round cable 200. As shown in FIG. 9, the difference of the seventh embodiment from the sixth embodiment only lies in that the type and the number of the wire cores on the periphery of the auxiliary wire 1 are different. The auxiliary wire 1 is located at the central position of the cable core, six of the power wire cores or other functional wire cores surround outside auxiliary wire 1.

In the embodiment, the flat cable sheath 4 outside the cable core can be of a double-layer sheath structure or a single-layer sheath structure. The single-layer sheath structure can be made of rubber (such as neoprene rubber and chlorinated polyethylene rubber), an elastomer and other suitable polymer materials, and the colors thereof can be black, full colors, translucent color and transparent color. When the round cable sheath 4 is of a double-layer sheath structure, the round cable sheath 4 includes an inner sheath layer and an outer sheath layer sleeving the outside of the inner sheath layer. Both the inner sheath layer and the outer sheath layer can be made of rubber, an elastomer and other suitable polymer materials, and the colors thereof can be black, full colors, translucent color and transparent color. A reinforcing layer can further be arranged between the inner sheath layer and the outer sheath layer, and the reinforcing layer can specifically be a fiber braided reinforcing layer or a metal wire wound reinforcing layer. The sheath layer is generally arranged according to the design requirements, and may or may not be arranged.

The round cable provided by the technical scheme is provided with the auxiliary wire 1 including the loose jacket protective layer, 1, so that the service life of the cable is greatly prolonged, and then the economic benefits of users improved.

### The Eighth Embodiment

The embodiment provides a cable. The cable includes a cable core. The cable core includes an auxiliary wire 1 and other functional wire cores surrounding the auxiliary wire core 1.

The cable provided by the technical scheme is provided with the auxiliary wire 1 including the loose jacket protective layer 1, so that the service life of the cable is greatly prolonged, and then the economic benefits of users improved.

It needs to be noted that for those skilled in the art, obviously the present disclosure is not limited to the details of the exemplary embodiment, and the present disclosure can be achieved in other specific forms without departing from the spirit or essential characteristics of the present disclosure. Therefore, for every point, the embodiments should be regarded as exemplary embodiments and are unrestrictive, and the scope of the present disclosure is restricted by the claims appended hereto. Therefore, all changes, falling in the meanings and scopes of equivalent elements, of the claims are aimed to be included in the present disclosure, and any reference signs of attached figures in the claims should not be regarded as limitation to the involved claims.

Specific examples are used for illustration of the principles and embodiments of the present disclosure. The description of the above-mentioned embodiments is used to help illustrate the method and its core principles of the present disclosure. In addition, those skilled in the art can make various modifications in terms of specific embodiments and scope of application in accordance with the teachings of the present disclosure. In summary, the contents of this specification should not be understood as the limitation of the present disclosure.

What is claimed is:

1. An auxiliary wire, comprising:
an auxiliary wire core, comprising one wire core or being formed by twisting a plurality of wire cores;
a loose jacket protective layer, wherein the loose jacket protective layer sleeves outside of the auxiliary wire core and is able to slide along a length direction of the auxiliary wire core relative to the auxiliary wire core; the loose jacket protective layer is formed by tube extrusion of polymer materials or by winding a steel wire around the auxiliary wire core.

2. The auxiliary wire according to claim 1, further comprising an outer protective layer of polymer material, wherein the outer protective layer of polymer material sleeves outside of the loose jacket protective layer.

3. The auxiliary wire according to claim 1, further comprising a shielding layer sleeving an outer layer of the loose jacket protective layer.

4. The auxiliary wire according to claim 1, wherein the auxiliary wire is a control wire, a communication wire or an optical fiber.

5. A flat cable, comprising a flat cable sheath, a power wire core and the auxiliary wire according to claim 1, wherein the power wire core and the auxiliary wire are both arranged in the flat cable sheath, and the power wire core and the auxiliary wire are arranged in parallel along a width direction of the flat cable sheath.

6. The flat cable according to claim 5, wherein three power wire cores, comprising a first power wire core, a second power wire core and a third power wire core, are provided; the first power wire core, the second power wire core and the third power wire core are arranged at equal intervals along the width direction of the flat cable sheath, and one auxiliary wire is arranged between the first power wire core and the second power wire core and another auxiliary wire is arranged between the second power wire core and the third power wire core; wherein the auxiliary wire between the first power wire core and the second power wire core is a control wire, and the control wire is externally tangential with the first power wire core and arranged at an interval with the second power wire core; and the auxiliary wire located between the second power wire core and the third power wire core is an optical fiber, and the optical fiber is externally tangential with the third power wire core and arranged at an interval with the second power wire core.

7. A round cable, comprising a cable core and a round cable sheath covered outside of the cable core, wherein the cable core comprises the auxiliary wire according to of claim 1.

8. The round cable according to claim 7, wherein the cable core is formed by twisting power wire cores, a ground wire core, a grounding detection wire core and the auxiliary wire, wherein the power wire cores comprise three power wire cores, the three power wire cores are mutually twisted tangentially in pair, the ground wire core, the grounding detection wire core and the auxiliary wire respectively comprise one ground wire core, one grounding detection wire core and one auxiliary wire, and the ground wire core, the grounding detection wire core and the auxiliary wire are respectively tangentially placed in gaps between every two adjacent power wire cores; and the auxiliary wire is a communication wire.

9. The round cable according to claim 7, wherein the cable core is formed by twisting power wire cores, a ground wire core and the auxiliary wire, wherein the power wire cores comprise three power wire cores, the ground wire core and the auxiliary wire respectively comprise one ground wire core and one auxiliary wire, the auxiliary wire is a control wire or a communication wire, the auxiliary wire and the three power wire cores are mutually twisted tangentially in pair, and the ground wire core is located at a center position of the auxiliary wire and the three power wire cores.

10. The round cable according to claim 7, wherein the round cable sheath is of a single-layer sheath structure or a multi-layer sheath structure.

11. The auxiliary wire according to claim 2, further comprising a shielding layer sleeving an outer layer of the loose jacket protective layer.

12. The auxiliary wire according to claim 2, wherein the auxiliary wire is a control wire, a communication wire or an optical fiber.

13. The flat cable according to claim 5, further comprising an outer protective layer of polymer material, wherein the outer protective layer of polymer material sleeves outside of the loose jacket protective layer.

14. The flat cable according to claim 5, further comprising a shielding layer sleeving an outer layer of the loose jacket protective layer.

15. The round cable according to claim 7, further comprising an outer protective layer of polymer material, wherein the outer protective layer of polymer material sleeves outside of the loose jacket protective layer.

16. The round cable according to claim 7, further comprising a shielding layer sleeving an outer layer of the loose jacket protective layer.

17. The round cable according to claim 8, wherein the round cable sheath is of a single-layer sheath structure or a multi-layer sheath structure.

18. The round cable according to claim 9, wherein the round cable sheath is of a single-layer sheath structure or a multi-layer sheath structure.

19. The round cable according to claim 7, wherein the cable core is formed by twisting power wire cores, a ground wire core and the auxiliary wire according to of claim 2, wherein the power wire cores comprise three power wire cores, the ground wire core and the auxiliary wire respectively comprise one ground wire core and one auxiliary wire, the auxiliary wire is a control wire or a communication wire, the auxiliary wire and the three power wire cores are mutually twisted tangentially in pair, and the ground wire core is located at a center position of the auxiliary wire and the three power wire cores.

20. The round cable according to claim 7, wherein the cable core is formed by twisting power wire cores, a ground wire core and the auxiliary wire according to of claim 3, wherein the power wire cores comprise three power wire cores, the ground wire core and the auxiliary wire respectively comprise one ground wire core and one auxiliary wire, the auxiliary wire is a control wire or a communication wire, the auxiliary wire and the three power wire cores are mutually twisted tangentially in pair, and the ground wire core is located at a center position of the auxiliary wire and the three power wire cores.
